(19) United States
(12) Patent Application Publication
(10) Pub. No.: US 2026/0260638 A1
(43) Pub. Date: Sep. 3, 2026

(54) Assembled Electronic Musical Instrument for Children

(71) Applicant: Zhiquan LIN, Guangdong (CN)

(72) Inventor: Zhiquan LIN, Guangdong (CN)

(21) Appl. No.: 19/067,853

(22) Filed: Mar. 1, 2025

(51) Int. Cl. G10H 1/34; G10H 1/00

(52) U.S. Cl. CPC G10H 1/342; G10H 1/0008; G10H 1/344; G10H 2220/221; G10H 2220/265

(57) ABSTRACT

The present disclosure provides an assembled electronic musical instrument for children, comprising a box body and an operation panel. The box body includes a plurality of splicing plates detachably connected to each other to form the box body. The box body is provided with an installation cavity having an opening, and the operation panel is detachably installed at the opening. The installation cavity is provided with a control circuit board, and the operation panel is provided with a pick mechanism for operating the control circuit board to produce sound. The operation panel is further provided with a keyboard mechanism for operating the control circuit board and produce different tones.

### TECHNICAL FIELD

The present disclosure relates to the technical field of children's musical instrument toys, and specifically relates to an assembled electronic musical instrument for children.

### BACKGROUND

With the advancement of technology and the evolution of children's education concepts, an increasing number of educational tools for children are focusing on nurturing creativity, hands-on skills, and musical literacy. In this context, electronic musical instruments for children, as an emerging educational and entertainment product, are gradually gaining favor among parents and educational institutions. These instruments not only provide children with rich musical experiences but also stimulate their interest in learning and spirit of exploration through highly interactive designs.

The existing U.S. Pat. No. 6,454,627 discloses a “Musical entertainment doll.” The patent features a one-piece enclosed design that cannot be disassembled or assembled. Children can only trigger music playback through preset buttons, lacking opportunities to explore the structure and functional modules of the instrument, which limits the development of hands-on skills and creativity, and limits children's creativity and desire to explore. Additionally, the patent has a single function, insufficient interactivity, and lacks diversity in sound effects, making it difficult to sustain children's long-term interest.

Therefore, it is necessary to propose a new type of assembled electronic musical instrument for children to address the aforementioned issues.

### SUMMARY

The present disclosure provides a assembled electronic musical instrument for children to solve the problems mentioned in the background technology.

To achieve the above-mentioned objective, the present disclosure adopts the following technical solution:

An assembled electronic musical instrument for children includes a box body and an operation panel, wherein the box body comprises a plurality of splicing plates detachably connected to each other to form the box body; and the box body is provided with an installation cavity having an opening, and the operation panel is detachably installed at the opening; and the installation cavity is provided with a control circuit board, the operation panel is provided with a pick mechanism to control the control circuit board to produce sound, and the operation panel is further provided with a keyboard mechanism to control the control circuit board and produce different tones.

The present disclosure further provides an assembled electronic musical instrument for children, which includes a box body and an operation panel, wherein the box body is provided with an installation cavity having an opening, and the operation panel is detachably installed at the opening; and the installation cavity is provided with a control circuit board, and the operation panel is provided with a control device for operating the control circuit board to produce sound; and the control device comprises a keyboard mechanism for operating the control circuit board and producing different tones.

### BRIEF DESCRIPTION OF DRAWINGS

The drawings, which form a part of this application, are used to provide a further understanding of the present disclosure. The illustrative embodiments and the descriptions thereof are used to explain the present disclosure and do not constitute an improper limitation of the present disclosure. In the drawings:

FIG. 1 is a schematic diagram of the structure of the present disclosure;

FIG. 2 is a schematic diagram of the structure of the second button of the present disclosure;

FIG. 3 is a schematic diagram of the internal structure of the present disclosure;

FIG. 4 is a schematic diagram of the structure of the operation panel of the present disclosure;

FIG. 5 is a schematic diagram of the structure of the splicing plate with a snap of the present disclosure;

FIG. 6 is a schematic diagram of the structure of the splicing plate with a slot of the present disclosure;

FIG. 7 is a schematic diagram of the control circuit board, keyboard mechanism, and toggle mechanism of the present disclosure;

FIG. 8 is a schematic diagram of another internal perspective of the present disclosure;

FIG. 9 is a schematic diagram of another embodiment of the present disclosure.

FIG. 10 is a schematic diagram of another embodiment of the present disclosure with the operation keyboard removed.

Reference signs: Box body (100); Splicing plate (110); Snap (111); Slot (112); Installation cavity (120); Decorative plate (130); Movable pick (140); Operation panel (200); First through slot (210); Second through slot (220); Sound hole (230); Control circuit board (300); First button (310); Second button (320); Power switch (330); Power supply (340); Speaker (350); Volume adjustment switch (360); Operation keyboard (400); Elastic sheet (410); Strip slot (500).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

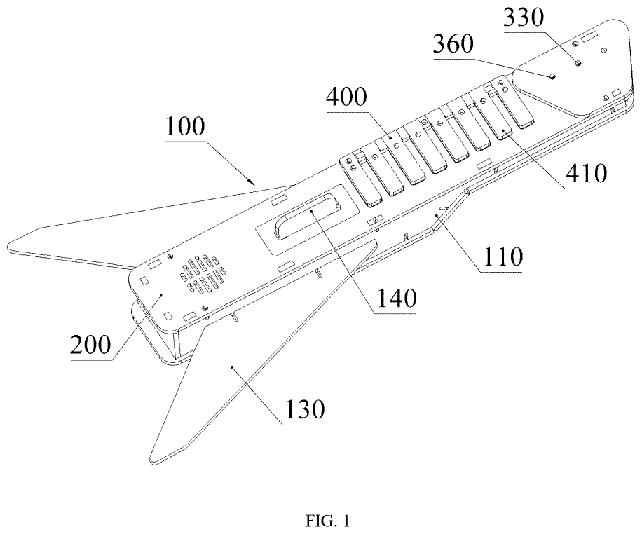

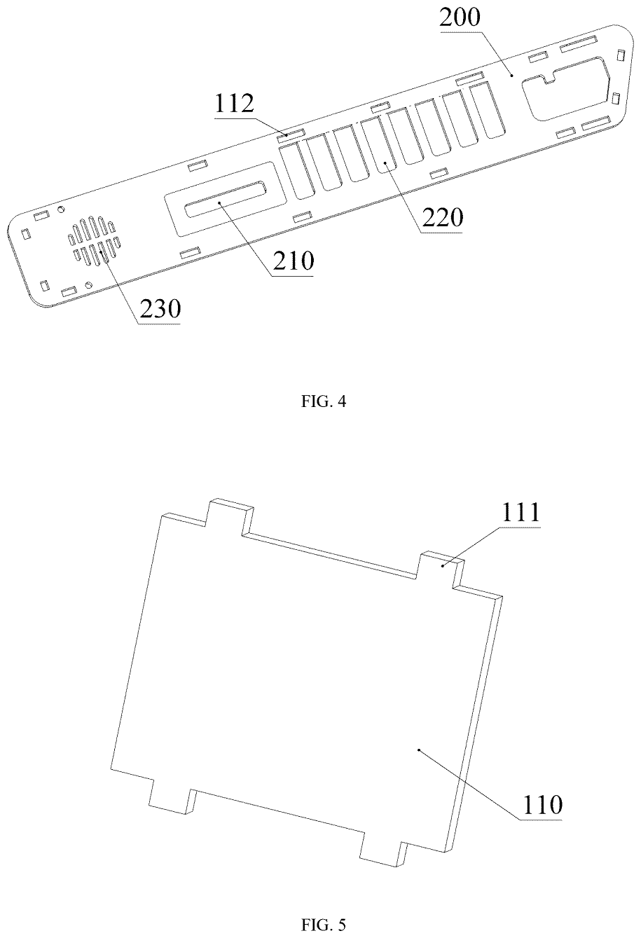

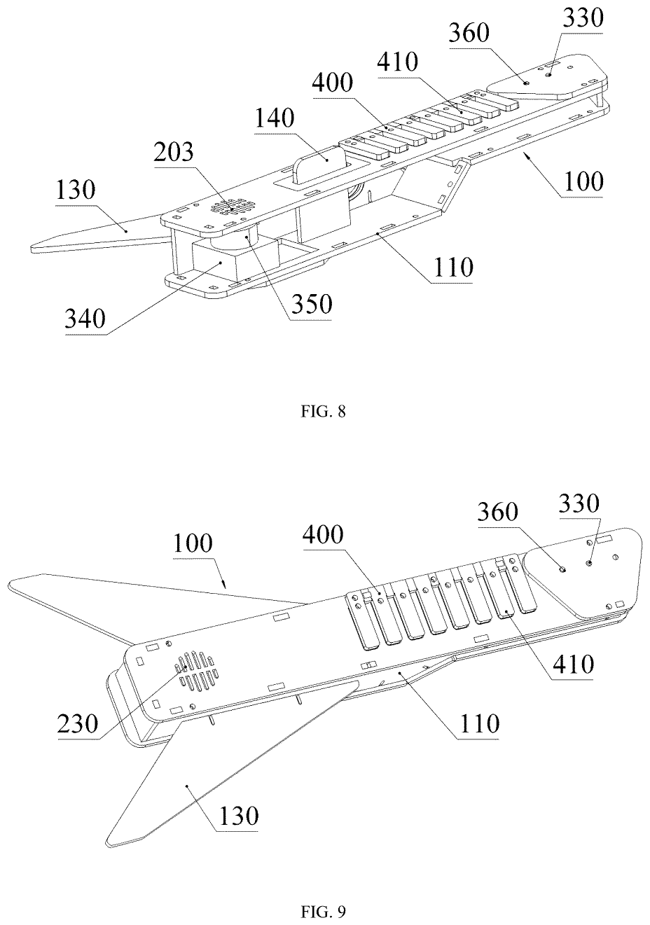

As shown in FIGS. 1 to 8, the present disclosure discloses an assembled electronic musical instrument for children, including a box body 100 and an operation panel 200. The box body 100 includes a plurality of splicing plates 110, which are detachably connected to each other to form the box body 100. The box body 100 is provided with an installation cavity 120, which has an opening, and the operation panel 200 is detachably installed at the opening. Inside the installation cavity 120, there is a control circuit board 300. The operation panel 200 is provided with a pick mechanism that operates the control circuit board 300 to produce sound, and it also has a keyboard mechanism that operates the control circuit board 300 to produce different tones.

Please refer to FIGS. 1 to 5. In this embodiment, the box body 100 is formed by a plurality of splicing plates 110 assembled together through snap-fit structures, and the operation panel 200 is also in the form of splicing plates 110, detachably connected to the box body 100. The splicing plates at the joints are respectively provided with snaps 111 and slots 112, which correspond to each other. The number of slots 112 and snaps 111 can be set according to the length of the splicing plates 110 and specific usage scenarios. For example, longer splicing plates 110 can have a plurality of snaps 111 and slots 112 to enhance splicing stability. During assembly, the snaps 111 are aligned with the slots 112 and pressed into the slots 112 to complete the installation, which is simple and quick, suitable for children to complete independently. After splicing, screws can be added at the joints for additional fixation, which can further enhance the overall strength of the box body 100, making it less likely to loosen or deform during children's use;

The connection method of snaps 111 and slots 112 supports repeated assembly and disassembly. During disassembly, the snaps 111 are simply removed from the slots 112 to separate the splicing plates 110, which is simple and does not damage the structure. The detachable design allows the splicing plates 110 to be separated when not in use, reducing space occupation and making it easy to store and carry. This design also lowers transportation and storage costs.

The splicing process requires children to align the snaps 111 with the slots 112 and press for fixation. This operation can exercise children's hand-eye coordination and fine motor skills. Through assembly, children's hand-eye coordination and creativity can be improved. By freely splicing, children can design different shapes and structures of the box body 100, stimulating creativity and spatial imagination. The assembly process involves logical thinking and problem-solving skills, such as how to choose splicing plates 110 and how to fix the structure, which helps in the intellectual development and cognitive ability enhancement of children.

In other embodiments (not shown), the connections between the splicing plates 110, and between the operation panel 200 and the box body 100 can also be achieved through magnetic adsorption and screw fixation. For example, by magnetic adsorption, magnets are embedded in the splicing plate 110, with the polarity of the magnets symmetrically distributed on each splicing plate 110, ensuring automatic alignment during splicing. Children only need to align the magnetic surfaces of two splicing plates 110 close to each other, and the attraction between the magnets will automatically guide the splicing plates 110 to align for fixation; precise alignment of the snap 111 and the slot 112 is not required, making the operation simple and fast, which is suitable for younger children with weaker hand strength. With screw fixation, symmetrical screw holes are reserved on the splicing edges of the splicing plate 110, and hand-twist screwdrivers or child-safe screwdrivers are used to screw screws into the screw holes, enhancing structural stability through screw tightening; magnetic adsorption and screw fixation can also be used in combination to balance convenience and stability.

In another embodiment (not shown), the box body 100 can also be an integrated structure, providing a pre-assembled non-detachable integrated structure for younger users to prevent disassembly.

Please refer to FIGS. 1, 3, and 8, in this embodiment, the installation cavity 120 is provided with a speaker 350 and a power supply 340. The speaker 350 is installed on the side close to the operation panel 200, and the operation panel 200 is provided with sound holes 230. The speaker 350 corresponds to the sound holes 230 on the operation panel 200, ensuring clear sound transmission; the power supply 340 is located below the speaker 350 and installed in a stacked manner. The power supply 340 is battery-powered, and both the speaker 350 and the power supply 340 are electrically connected to the control circuit board 300 via wires. The control circuit board 300 is installed on the side of the operation panel 200 located within the installation cavity 120 and fixed with screws. The control circuit board 300 is also equipped with a power switch 330 and a volume adjustment switch 360 that extend through the operation panel 200. The power switch 330 and the volume adjustment switch 360 are located at the end away from the sound holes 230 on the operation panel 200, and both the power switch 330 and the volume adjustment switch 360 are press switches.

In other embodiments (not shown), the power supply 340 can also be a rechargeable lithium battery or powered through an external plug. Using a rechargeable lithium battery, a charging interface is set on the box body 100 to charge the lithium battery. The lithium battery power supply allows the box body 100 to be used without an external power supply, which is suitable for outdoor or mobile scenarios, and repeated charging reduces the frequency of battery replacement, lowering environmental pollution. Using an external plug power supply, a power socket is set on the box body 100, preferably near the speaker 350, and powered through a power adapter. The external power supply is suitable for long-term use, avoiding the issue of insufficient battery power. The box body 100 can also have both a built-in rechargeable lithium battery and an external power socket, allowing users to choose the power supply method according to the usage scenario. For daily use, the lithium battery can be used, and for long-term use, it can be switched to the external power supply, combining the advantages of both the lithium battery and the external power supply to meet multi-scenario needs.

In other embodiments (not shown), the power supply 340, speaker 350, volume adjustment switch 360, and power switch 330 can be set at different positions according to actual needs, and the speaker 350

The number of speakers 350 can be one or more, and the position of the speakers 350 correspond to the sound holes 230.

In other embodiments (not shown), the volume adjustment switch 360 and the power switch 330 can also be touch-sensitive switches. For example, the touch-sensitive volume adjustment switch 360 is located on the side or top of the operation panel 200. With the capacitive touch sensing technology, users can adjust the volume by sliding their fingers on the sensing area, sliding up to increase the volume and sliding down to decrease it. The switch has built-in LED indicators to display the volume level in real-time. The touch-sensitive power switch allows users to turn the power supply 340 on or off with a light touch, and a child lock mode can be added. Long-pressing the power switch 330 locks the touch function to prevent accidental touches during use.

In other embodiments (not shown), the installation position of the control circuit board 300 can be set at different positions according to actual needs. The power switch 330, volume adjustment switch 360, first button 310, and second button 320 are electrically connected to the control circuit board 300 through wires for control.

Please refer to FIGS. 1, 3, 4, and 7, in this embodiment, a pick mechanism is used to simulate the strumming effect of a guitar. The pick mechanism includes a movable pick 140 that is rotatably installed in the installation cavity 120. The movable pick 140 is rotatably installed in the installation cavity 120 via a rotating shaft. The operation panel 200 is provided with a first through slot 210, and one end of the movable pick 140 extends through the first through slot 210 and protrudes outward. There is a gap between the first through slot 210 and the movable pick 140. The width of the first through slot 210 is greater than the thickness of the pick, allowing the movable pick 140 to move within the first through slot 210. The control circuit board 300 is provided with a first button 310 located on one side of the first through slot 210. The first button 310 is a press switch, and it abuts against one side of the movable pick 140. When the movable pick 140 is plucked, it rotates around the rotating shaft and abuts against the first button 310.

In other embodiments (not shown), the first button 310 can be a pressure sensor and a multi-stage switch. The pressure sensor generates sound effects of different intensities based on different pulling forces. Different plucking force and speed of the movable pick 140 can generate different sound effects. The harder the plucking, the more intense the sound effect, simulating the dynamics of real musical instruments. Children can explore different sound effects by changing the pulling force, stimulating creativity. The multi-stage switch is divided into several physical segments, each corresponding to different circuit contacts, triggering independent sound modes. When the movable pick 140 is plucked, it presses different segments of the multi-stage switch based on its rotation angle or position, producing different sound effects.

Please refer to FIGS. 1, 2, 3, and 6. In this embodiment, the operation panel 200 is also uniformly provided with a plurality of second through slots 220, and the number of the second through slots 220 is eight. The keyboard mechanism includes an operation keyboard 400 and a plurality of second buttons 320. The second buttons 320 are press switches, and the number of the second buttons 320 corresponds to the number of the second through slots 220, which is also eight. The plurality of second buttons 320 are respectively installed on the control circuit board 300, and each second button 320 is located within each second through slot 220. The operation keyboard 400 is detachably installed on the operation panel 200 via screws. The operation keyboard 400 includes a plurality of elastic sheets 410, which are made of a material with good elasticity. The number of the elastic sheets 410 corresponds to the number of the second through slots 220, which is also eight. The plurality of elastic sheets 410 are respectively located above the second through slot s220. The size of the second through slot 220 is slightly larger than that of the elastic sheet 410, ensuring that there is no friction between the elastic sheet 410 and the second through slot 220 when the elastic sheet 410 is pressed. Each second button 320 within the second through slot 220 is in contact with the elastic sheet 410 on the same side. When the elastic sheet 410 of the operation keyboard 400 is pressed, the elastic sheet 410 deforms downward, pressing the second button 320. Each second button 320 corresponds to an independent musical note, and pressing different elastic sheets 410 can generate different tones.

In other embodiments (not shown), the second button 320 can be a pressure sensor. The pressure sensor generates sound effects of different intensities based on different pressing forces. Different pressing forces on the elastic sheet 410 can generate different sound effect variations. The harder the press, the more intense the sound effect, simulating the dynamic expression of real musical instruments. Children can explore different sound effects by changing the pressing force, stimulating creativity.

In other embodiments (not shown), a light-emitting component is arranged below the elastic sheet 410 of the operation keyboard 400 to enhance the aesthetics and functionality of the device. The light-emitting component can be switched to different colors and flashing frequencies by pressing different elastic sheets 410, providing diverse visual effects and further improving the user experience. The light-emitting component can be an LED light and a light guide tube, etc. When pressed, the light turns on, enhancing the visual effect and improving the user experience.

Please refer to FIG. 1, FIG. 3, and FIG. 7. In this embodiment, the control circuit board 300 is provided with a processor and a signal receiver, capable of receiving electrical signals generated by the first button 310 and the second button 320. When the first button 310 or the second button 320 is pressed, these buttons generate corresponding electrical signals. The first button 310 is typically associated with a pick mechanism, used to generate strumming sound effects; the second button 320 is associated with a keyboard mechanism for generating notes of different pitches. When each button is pressed, the corresponding electrical signal is transmitted to the control circuit board 300 via the signal receiver. The signal receiver converts the analog signals from the buttons into digital signals and sends them to the processor inside the control circuit board 300.

After the processor receives the signals, it identifies the corresponding notes or scales based on the electrical signals input from different buttons. The processor further processes the electrical signals, such as adjusting volume and sound effects (e.g., clarity, timbre). The processor generates audio signals corresponding to the pressed buttons based on pre-programmed scale tables or sound libraries through algorithms. The processed digital audio signals are then transmitted to the speaker 350, which receives and converts the digital signals into sound waveforms, producing the corresponding sound through the vibration of the speaker 350.

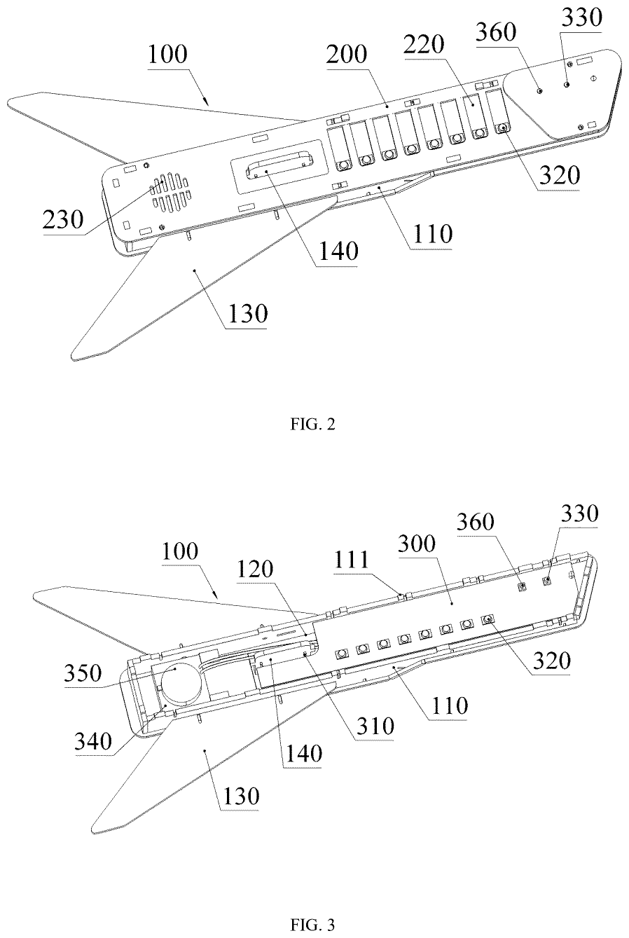

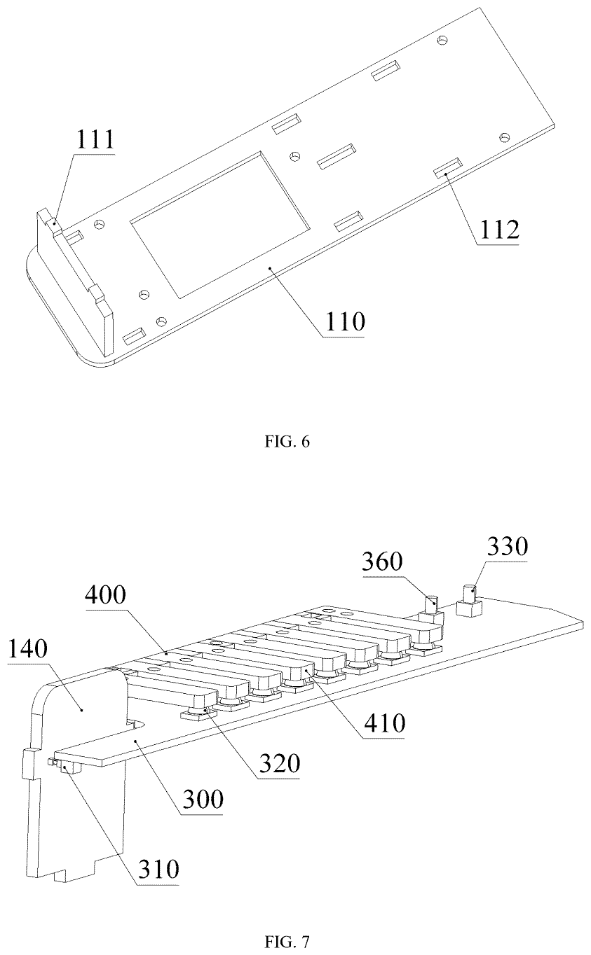

Please refer to FIG. 1, FIG. 2, and FIG. 6. In this embodiment, the box body 100 is elongated, and one end along the length direction is provided with a decorative plate 130. The decorative plate 130 is connected to the box body 100 via snaps 111 and slots 112, giving it a shape similar to a guitar. The pick mechanism is positioned near the decorative plate 130, while the keyboard mechanism is positioned away from the decorative plate 130. When in use, the power switch 330 is pressed to be turned on, then the volume is adjusted to an appropriate level using the volume adjustment switch 360. For playing, the elastic sheet 410 on the keyboard mechanism is first pressed, and then the movable pick 140 is plucked to produce sound.

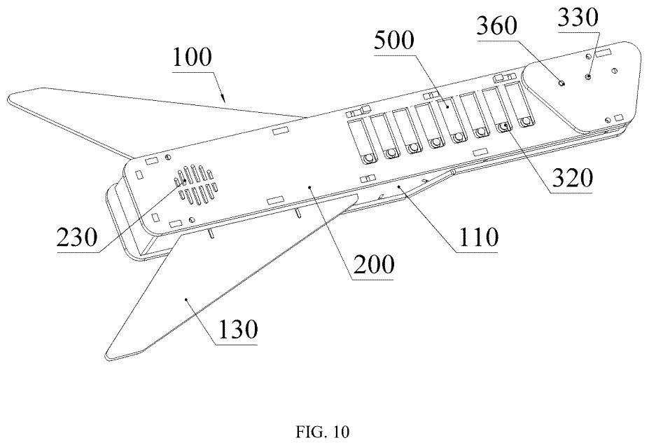

Please refer to FIGS. 9 and 10, in another embodiment, the operation panel 200 is detachably mounted on the box body 100, and the operation panel 200 is provided with a control device that manipulates the control circuit board 300 to produce sound. The control device includes a keyboard mechanism for manipulating the control circuit board 300 and generating different tones. The operation panel 200 is uniformly provided with a plurality of strip slots 500, and the number and distribution of these strip slots 500 can be adjusted according to user needs. The keyboard mechanism includes an operation keyboard 400 and a plurality of second buttons 320, and the plurality of second buttons 320 are respectively set in respective strip slots. The operation keyboard 400 is detachably installed on the operation panel 200. The operation keyboard 400 includes a plurality of elastic sheets 410 that are respectively located above respective strip slots 500, and the second button 320 in each strip slot 500 is in contact with the elastic sheet 410 on the same side. When the user presses the elastic sheet 410, the elastic sheet 410 will bend downward, pressing the corresponding second button 320, thereby triggering the electronic switch inside the control circuit board 300. At this time, the action of the second button 320 will send a signal to the control circuit board 300, controlling the tone and timbre of the sound output.

In the above embodiment, the design of the box body 100 can adopt a piano-like structure to enhance children's operational experience with the instrument and the fun of music education. The elastic sheets 410 mimic the function of piano keys, and when the user presses the elastic sheet 410, the elastic sheet 410 will deform according to the pressing force and direction, similar to the pressing behavior of piano keys, producing different sound effects based on different pressing forces.

In another embodiment (not shown), the box body 100 can also be partially shaped like a flute. The scale is controlled through the keyboard mechanism, each tuning key corresponds to a second button 320, and the scale is changed when the tuning key is pressed. A blowing sensor is added, and the sensor is triggered when blowing, simulating the sound of a flute.

In summary, as can be seen from the above description, the present disclosure achieves the following technical effects:

The box body 100 is formed by splicing a plurality of splicing plates 110, and with the structure of snaps 111 and slots 112, splicing or disassembly can be completed by simply aligning and pressing; the operation is simple and fast, which is very suitable for children to operate independently; this design helps to exercise children's hand-eye coordination and fine motor skills, while enhancing the interactivity of the instrument; the flexibility of the splicing plates 110 allows the instrument to be adjusted according to the age and ability of the child, younger children can operate through simple splicing, while older children can challenge more complex splicing structures, fully adapting to the needs of children of different ages; the detachable splicing design reduces the overall volume of the product, making transportation and storage more convenient and economical.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. An assembled electronic musical instrument for children, comprising a box body and an operation panel, wherein
the box body comprises a plurality of splicing plates detachably connected to each other to form the box body; and
the box body is provided with an installation cavity having an opening, and the operation panel is detachably installed at the opening; and
the installation cavity is provided with a control circuit board, the operation panel is provided with a pick mechanism to control the control circuit board to produce sound, and the operation panel is further provided with a keyboard mechanism to control the control circuit board and produce different tones.

2. The assembled electronic musical instrument for children according to claim 1, wherein the installation cavity is provided with a speaker and a power supply, both of which are electrically connected to the control circuit board.

3. The assembled electronic musical instrument for children according to claim 1, wherein the control circuit board is installed on one side of the operation panel located within the installation cavity.

4. The assembled electronic musical instrument for children according to claim 3, wherein the pick mechanism comprises a movable pick rotatably installed within the installation cavity.

5. The assembled electronic musical instrument for children according to claim 4, wherein the operation panel is provided with a first through slot, and one end of the movable pick extends through the first through slot and protrudes outward.

6. The assembled electronic musical instrument for children according to claim 5, wherein there is a gap between the first through slot and the movable pick, allowing the movable pick to move within the first through slot.

7. The assembled electronic musical instrument for children according to claim 5, wherein the control circuit board is provided with a first button located on one side of the first through slot, and the first button abuts against one side of the movable pick.

8. The assembled electronic musical instrument for children according to claim 3, wherein the operation panel 200 is further uniformly provided with a plurality of second through slots.

9. The assembled electronic musical instrument for children according to claim 8, wherein the keyboard mechanism comprises an operation keyboard and a plurality of second buttons, with the plurality of second buttons installed on the control circuit board and respectively located within respective second through slots.

10. The assembled electronic musical instrument for children according to claim 9, wherein the operation keyboard is detachably installed on the operation panel, and the operation keyboard comprises a plurality of elastic sheets.

11. The assembled electronic musical instrument for children according to claim 10, wherein the plurality of elastic sheets are respectively located above each second through slot, and the second button in each second through slot abuts against the elastic sheet on a same side.

12. The assembled electronic musical instrument for children according to claim 3, wherein the control circuit board is further provided with a power switch that extends through the operation panel.

13. A assembled electronic musical instrument for children, comprising a box body and an operation panel, wherein
the box body is provided with an installation cavity having an opening, and the operation panel is detachably installed at the opening; and
the installation cavity is provided with a control circuit board, and the operation panel is provided with a control device for operating the control circuit board to produce sound; and
the control device comprises a keyboard mechanism for operating the control circuit board and producing different tones.

14. The assembled electronic musical instrument for children according to claim 13, wherein the box body comprises a plurality of splicing plates, and the plurality of splicing plates are detachably connected to each other to form the box body.

15. The assembled electronic musical instrument for children according to claim 13, wherein the keyboard mechanism comprises an operation keyboard and a plurality of second buttons, and the plurality of second buttons are electrically connected to the control circuit board.

16. The assembled electronic musical instrument for children according to claim 15, wherein the operation panel is uniformly provided with a plurality of strip slots, and the plurality of second buttons are respectively arranged in respective strip slots.

17. The assembled electronic musical instrument for children according to claim 16, wherein the operation keyboard is detachably installed on the operation panel, and the operation keyboard comprises a plurality of elastic sheets; and
the plurality of elastic sheets are respectively located above respective strip slots, and the second button in each strip slot abuts against the elastic sheet on a same side.

18. The assembled electronic musical instrument for children according to claim 13, wherein the control device further comprises a pick mechanism for controlling the control circuit board to produce sound, and the pick mechanism comprises a movable pick rotatably installed in the installation cavity.

19. The assembled electronic musical instrument for children according to claim 18, wherein the operation panel is provided with a first through slot, and one end of the movable pick extends through the first through slot and extends outward.

20. The assembled electronic musical instrument for children according to claim 19, wherein a first button electrically connected to the control circuit board is installed on the operation panel 200, and the first button abuts against one side of the movable pick.
